(19) United States
(12) Patent Application Publication
(10) Pub. No.: US 2012/0145354 A1
(43) Pub. Date: Jun. 14, 2012

(54) VEHICLE HAVING A DRIVE DEVICE

(75) Inventors: Tim Schaeffer, Niedersachswerfen (DE); Andreas Gutsch, Luedinghausen (DE)

(73) Assignee: LI-TEC BATTERY GMBH, KAMENZ (DE)

(21) Appl. No.: 13/380,638

(22) PCT Filed: Jun. 1, 2010
(86) PCT No.: PCT/EP10/03319

§ 371 Date: Mar. 2, 2012

(30) Foreign Application Priority Data
Jun. 25, 2009 (DE) 10 2009 030 541.6

(51) Int. Cl. B60H 1/22; B60L 1/02; B60H 1/32

(52) U.S. Cl. 165/44; 165/41; 62/239

(57) ABSTRACT

A vehicle has a driving apparatus that includes at least one propulsion device, a driving device that applies a force and/or a torque to the propulsion device, and an energy conversion device that receives energy from the driving device. A first energy storage device that stores energy is also included. The driving apparatus assumes a first operating state where a force and/or a torque is applied to the propulsion device by the driving device or a second operating state in which a force and/or a torque are applied to the driving device by the propulsion device. Under predefined conditions, a second energy storage device supplies energy to at least one driving device and the first energy storage device supplies energy to the second energy storage device.

The present invention relates to a vehicle having a driving apparatus, and is described particularly in conjunction with lithium ion batteries for supplying power to the driving apparatus. The invention further relates to a method for operating a vehicle having a driving apparatus according to the invention. It should be pointed out, however, that the invention can also be used independently of the design of the battery or independently of the type of drive to which power is supplied.

Vehicles having driving apparatus are known in the prior art. Some designs of said devices have more moderate degrees of efficiency.

WO 99/097804 describes a method for high-temperature accumulators for stationary energy storage and for land, water, air and space vehicles that are independent of the driving mains supply. A further problem addressed by said document is that of driving network-independent vehicles of all types with precisely the same or a greater level of comfort than is possible with combustion engines. The problem is solved in that, without combustion fuel, the greatest possible amount of heat per device of weight or space is stored in the high-temperature accumulator according to the invention, is saved for the longest possible period of time, and is then supplied as driving energy, as needed, with the greatest possible efficiency. The basic material used to solve this problem is graphite, which serves as the storage material, but at the same time is also used for conducting heat and current and for resistance heating. In addition to using graphite as a storage material in this sense, the method also uses other even higher capacity elements or compounds of elements having higher melting and evaporation enthalpies. Said document further specifies that the so-called “zero emissions car” then requires only an electronic control system, for wheel-drive motors, which can act as a generator during braking and can feed the braking energy in the form of thermal energy back into the accumulator.

The problem addressed by the invention is that of improving the efficiency of vehicles of this type having a driving apparatus.

This problem is solved according to the invention by the teaching of the independent claims. Preferred embodiments of the invention are the subject matter of the dependent claims.

The vehicle according to the invention is equipped with a driving apparatus comprising at least one propulsion device, a driving device, an energy conversion device and a first energy storage device. The driving device is provided for applying a force and/or a torque to the propulsion device. The energy conversion device is provided to be supplied with energy by the driving device. The first energy storage device is provided for storing energy. The driving apparatus is further provided to temporarily assume a first operating state, in which a force and/or a torque are applied to the propulsion device by the driving device, or to temporarily assume a second operating state, in which a force and/or a torque are applied to the driving device by the propulsion device. In the second operating state, the driving device and the energy conversion device are provided for supplying energy to the energy conversion device and/or the first energy storage device. The energy conversion device is provided for converting electrical energy into thermal energy.

A vehicle within the context of the invention is understood particularly as a land vehicle, a water craft, or an aircraft. The vehicle is preferably embodied for conveying at least one person. The land vehicle preferably has at least one wheel or a drive chain.

A driving apparatus within the context of the invention is understood as a device which particularly serves for driving a vehicle. The driving apparatus according to the invention comprises at least one propulsion device, a driving device, an energy conversion device, and a first energy storage device. According to the invention, the driving apparatus also serves to decelerate a vehicle. Particularly, during a deceleration of a vehicle, the driving apparatus converts kinetic energy into another form of energy and stores the converted energy. In the present case, a deceleration is also understood to mean that the kinetic energy of the propulsion device remains unchanged when an external load supplies energy to the vehicle, more particularly, during downhill travel and/or during coasting. The energy supplied by an external load is fed to the first energy storage device, particularly.

A propulsion device within the context of the invention is understood as a device which serves particularly for transmitting force to a body to be moved, a fluid, or the environment. Particularly, the propulsion device transfers a frictional force, a driving force, a torque, or even a momentum. Preferably, the propulsion device is particularly embodied as a gear wheel, a friction wheel, a pinion gear, a sprocket wheel, a pulley, a pump, a screw propeller, a propeller or even a turbine stage or expansion stage of a gas turbine.

A driving device within the context of the invention is understood as a device which is particularly provided for supplying force and/or torque to the propulsion device. The driving device is also provided particularly for being supplied with a force and/or a torque by the propulsion device. The driving device is preferably connected to the propulsion device by force fit and/or positive locking, more particularly, by way of a shaft, belt or chain. The driving device is preferably embodied as an electric motor, particularly preferably as a direct current motor. The driving device preferably supplies energy to the energy conversion device when a force and/or torque are supplied to the driving device by the propulsion device.

An energy conversion device within the context of the invention is understood as a device which serves particularly to convert the form of the energy. The energy conversion device is temporarily supplied with energy by the driving device. When the energy conversion device is supplied with energy by the driving device, the energy conversion device converts the form of the energy that is supplied. The energy conversion device also temporarily supplies converted energy to a first energy storage device. The energy conversion device is preferably selected on the basis of the design of the driving device and of the first energy storage device. The energy conversion device preferably converts energy into thermal energy. For this purpose, a driving device preferably supplies electrical energy to the energy conversion device. Further, the energy conversion device preferably supplies thermal energy to a first energy storage device. One energy conversion device is preferably supplied with energy by a plurality of driving devices. The energy conversion device preferably acts as an ohmic resistor. Particularly preferably, the energy conversion device is embodied as an electrical resistor. The energy conversion device preferably has a plurality of energy converters, particularly having different capacities and/or designs.

A first energy storage device within the context of the invention is understood as a device which particularly stores the energy supplied by the energy conversion device. The design of the first energy storage device is selected on the basis of the form of the energy that is supplied. The first energy storage device is preferably provided for supplying energy to a load in the vehicle. The first energy storage device is preferably embodied as a device for storing thermal energy. The first energy storage device preferably has at least one surrounding wall. Particularly preferably, the first energy storage device has particularly thermal insulation, at least in regions. At least one measuring device is preferably assigned to the first energy storage device, particularly for detecting the temperature. The first energy storage device is preferably embodied as having multiple parts, arranged at multiple locations within the vehicle. The first energy storage device preferably periodically supplies thermal energy as needed to the passenger compartment of the vehicle.

A first operating state within the context of the invention is understood as a state in which a force and/or a torque are applied to the propulsion device by the driving device. A vehicle is preferably accelerated in a first operating state. The kinetic energy of a vehicle is preferably held constant under an imposed load, wherein the imposed load acts substantially opposite to the greatest velocity vector of the vehicle.

A second operating state according to the invention is understood as a state in which a force and/or a torque are applied to the driving device by the propulsion device. The second operating state is preferably initiated by an operator of the vehicle. A vehicle is preferably decelerated in a second operating state. The kinetic energy of a vehicle is preferably held constant under an imposed load, wherein the imposed load acts substantially in the direction of the greatest velocity vector of the vehicle.

With the embodiment of the driving apparatus according to the invention, energy can be removed from the propulsion device in a second operating state, and, once the form of said energy has been converted, it can be supplied to the first energy storage device for storage. The energy stored in the first energy storage device is available for supply to a load in the vehicle. Advantageously, kinetic energy can be recovered in a second operating state. Advantageously, existing deceleration devices of the vehicle can be relieved, and the service life thereof can be increased. The problem that is addressed is thereby solved.

In what follows, preferred further developments of the invention are described.

The energy conversion device is advantageously encompassed at least partially by the first energy storage device. A plurality of energy conversion devices are preferably encompassed at least partially by the first energy storage device. The energy conversion device is preferably in particularly thermally conductive contact with an outer surface of the first energy storage device. The energy conversion device is preferably substantially completely encompassed by the first energy storage device. The arrangement of the energy conversion device inside the first energy storage device advantageously enables an efficient heat exchange. The energy conversion device preferably has a wall made of a thermally conductive material. The wall preferably has particularly ribs and/or pins, which serve to enlarge the thermally conductive surface of the energy conversion device.

Advantageously, the first energy storage device has at least one first substance which is capable of going through a phase transition. The first substance is preferably substantially completely encompassed by a wall of the first energy storage device. The first substance preferably encompasses the energy conversion device substantially completely and is in thermally conductive contact with the energy conversion device. The first substance is preferably selected such that the temperature of a phase transition is considerably lower than the operating temperature of the energy conversion device. The first substance is preferably selected such that the temperature of a phase transition temporarily lies at least 10 Kelvin below the operating temperatures of the energy conversion device. The first energy storage device preferably has at least two first substances having different phase transition temperatures.

Advantageously, the first substance of the first energy storage device is selected such that at a predefined temperature, it undergoes a phase transition from solid to liquid, preferably directly from solid to gaseous. In this case, the temperature of the phase transition is preferably selected on the basis of the operating temperatures of the energy conversion device. The temperature of a phase transition of the first substance preferably temporarily lies at least 10 Kelvin below the operating temperatures of the energy conversion device. The first substance is preferably embodied as a metallic alloy. The first substance is preferably selected according to the greatest possible phase transition enthalpy.

Advantageously, a second energy storage device is assigned to the driving apparatus. Said energy storage device is provided for supplying energy to the driving device. This second energy storage device is preferably a rechargeable battery, particularly preferably, a battery of high energy density. The electrolyte of the second energy storage device preferably comprises lithium ions. The second energy storage device preferably has at least one ceramic separator. At least one measuring device, particularly for detecting temperature, is preferably assigned to the second energy storage device. The second energy storage device is preferably embodied as comprising multiple parts, arranged in multiple locations inside the vehicle. The second energy storage device is preferably embodied as replaceable. A control device is preferably assigned to the second energy storage device.

Advantageously, under predefined conditions the first energy storage device supplies energy to the second energy storage device. The first energy storage device preferably supplies thermal energy to the second energy storage device. Predefined conditions are present particularly when the actual temperature of the second energy storage device drops below its minimum operating temperature. Advantageously, at low surrounding temperatures and/or with a slow electrolyte caused by low temperatures, the temperature of the second energy storage device, which is embodied as a battery, is increased by means of the first energy storage device. The second energy storage device preferably has at least one measuring device, particularly for detecting the temperature of the second energy storage device. A control device is preferably assigned to the driving apparatus. The control device particularly carries out the processing of the detected temperature of the second energy storage device, the comparison of the detected temperature with a predefined minimum temperature for the second energy storage device, and the initiation of a supplying of energy from the first energy storage device to the second energy storage device.

An absorption-type chiller is advantageously assigned to the driving apparatus. Under predefined conditions, the first energy storage device preferably supplies particularly thermal energy to the absorption-type chiller. Under predefined conditions, the second energy storage device preferably supplies particularly thermal energy to the absorption-type chiller. Predefined conditions are present particularly when the temperature of the first energy storage device, the second energy storage device, and/or the energy conversion device exceeds or threatens to exceed a maximum permissible operating temperature. A further predefined condition is satisfied when energy must be supplied to the absorption-type chiller for the functioning thereof. At least one measuring device each is preferably assigned to the first energy storage device, the second energy storage device, and/or the energy conversion device, particularly for detecting the respective temperature thereof. Energy is preferably supplied to the absorption-type chiller from the first and/or second energy storage device by way of a flowing fluid.

A vehicle according to the invention advantageously comprises a driving apparatus having an absorption-type chiller and a passenger compartment. The passenger compartment preferably has at least one measuring device, particularly for detecting the temperature of the passenger compartment. According to the invention, the absorption-type chiller carries particularly thermal energy away from the passenger compartment under predefined conditions. The passenger compartment preferably has a device for presetting a maximum desired temperature in the passenger compartment. Predefined conditions for carrying particularly thermal energy away from the passenger compartment are present particularly when the actual temperature inside the passenger compartment exceeds the maximum desired temperature. The absorption-type chiller of the driving apparatus is preferably supplied with energy, particularly thermal energy, by the first and/or second energy storage device. Thermal energy is preferably carried away from the passenger compartment by way of a flowing fluid.

The driving apparatus advantageously has at least two propulsion devices. The driving apparatus preferably has at least two driving devices. One propulsion device is preferably assigned to one driving device. The second energy storage device is preferably embodied as a rechargeable battery, particularly preferably as a replaceable, rechargeable battery. The vehicle preferably has at least three or four propulsion devices. At least one driving device is preferably embodied as an electric motor. Preferably, all the driving devices are embodied as electric motors. At least two driving devices are preferably synchronized in such a way that one driving device delivers a torque on the basis of the torques of the other driving devices.

Advantageously, a vehicle having a driving apparatus according to the invention is periodically operated in a second operating state. This second operating state is characterized in that a force and/or a torque are applied to the driving device by the propulsion device. The driving apparatus comprises at least one propulsion device, a driving device, an energy conversion device, and a first energy storage device. The method is characterized in that in the second operating state, the driving device supplies electrical energy to the energy conversion device. The energy conversion device then converts electrical energy into thermal energy, the energy conversion device supplies thermal energy to the first energy storage device, and the first energy storage device stores thermal energy. The properties of the individual devices and devices have already been described. The second operating state is preferably initiated by an operator of the vehicle.

A second energy storage device for supplying energy to the driving device and an absorption-type chiller are advantageously also assigned to the vehicle. A vehicle of this type is preferably operated such that under predefined conditions, the second energy storage device exchanges thermal energy with the first energy storage device. Under predefined conditions, the first energy storage device preferably supplies thermal energy to the second energy storage device. Under predefined conditions, thermal energy preferably flows in the opposite direction. Under predefined conditions, the second energy storage device preferably supplies thermal energy to the absorption-type chiller. Under predefined conditions, thermal energy preferably flows in the opposite direction. Predefined conditions are present particularly when the actual temperature of the first energy storage device and/or of the second energy storage device exceeds or threatens to exceed a permissible maximum temperature. In this case, the hotter energy storage device transfers thermal energy to the cooler energy storage device and/or absorption-type chiller. Predefined conditions are also present when the actual temperature of the second energy storage device drops below or threatens to drop below a minimum permissible operating temperature. In this case, thermal energy is supplied to the second energy storage device by the first energy storage device.

Additional advantages, features and potential applications for the present invention are presented in the following description, in reference to the set of drawings. The drawings show:

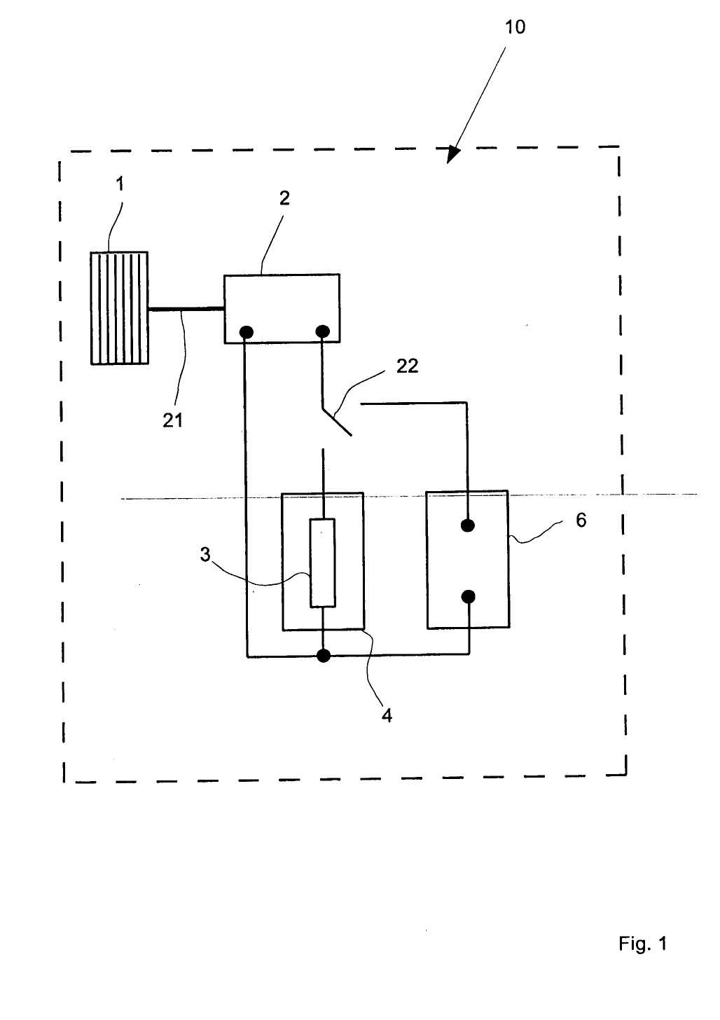

FIG. 1 a schematic illustration of a vehicle having a driving apparatus according to the invention,

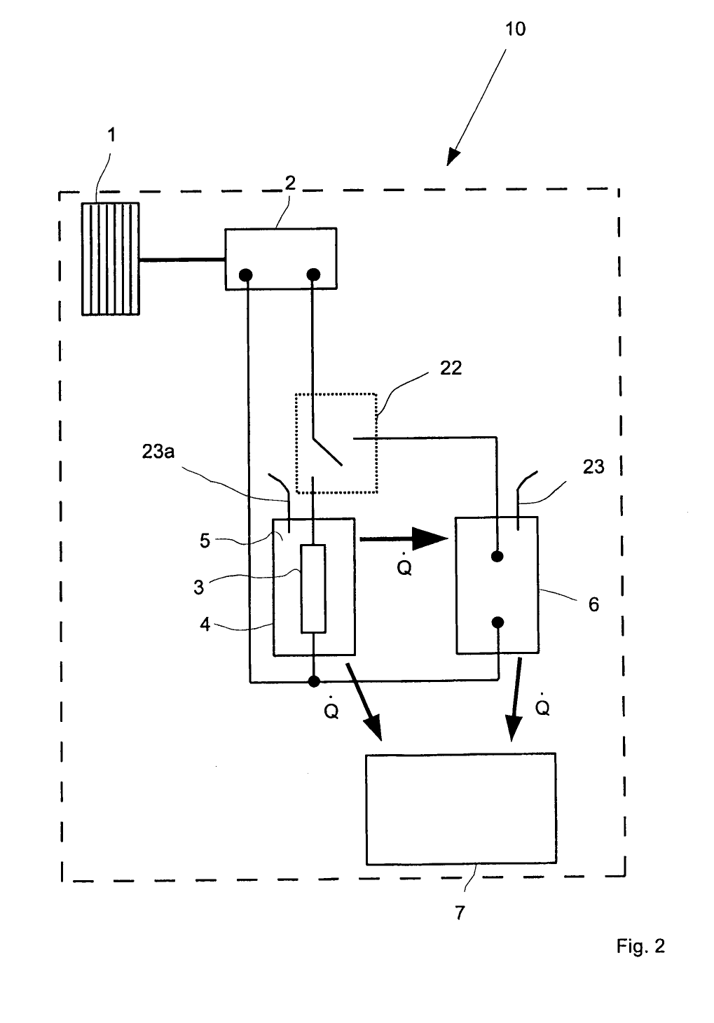

FIG. 2 a schematic illustration of an additional embodiment of the driving apparatus with temperature control of a replaceable battery, and

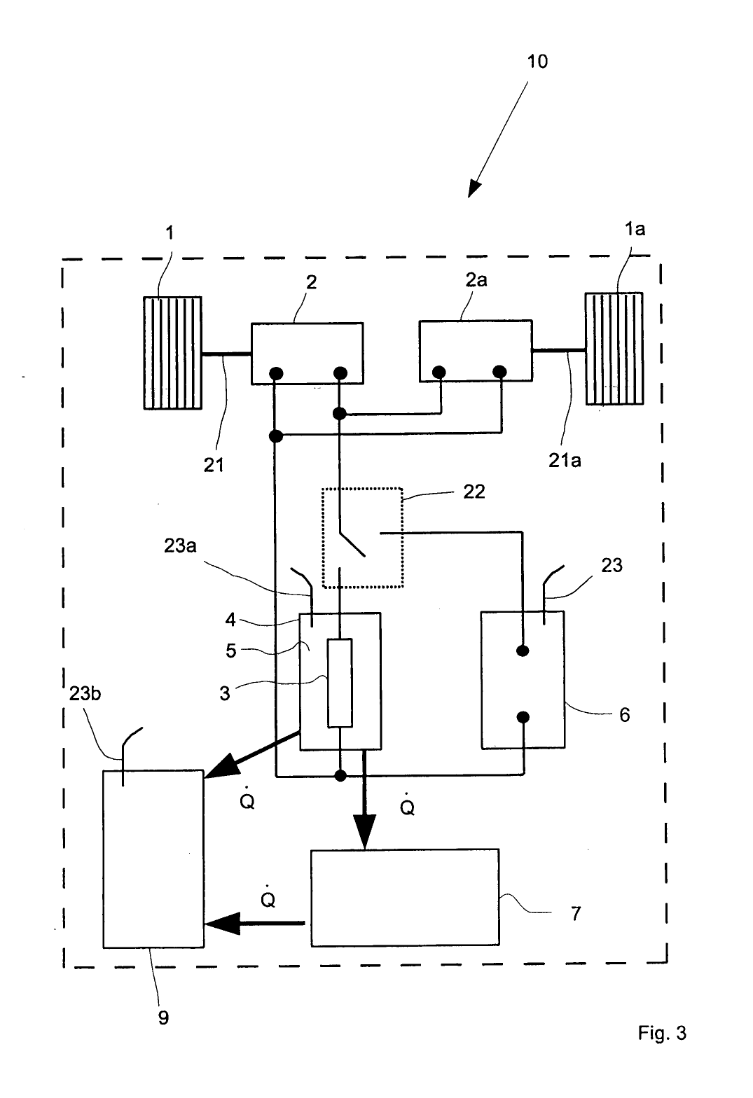

FIG. 3 a schematic illustration of an additional embodiment of the driving apparatus with temperature control of the passenger compartment of the vehicle.

FIG. 1 shows a vehicle having a driving apparatus 10 according to the invention. The vehicle is represented as a dashed outline around the driving apparatus 10.

The driving apparatus has a driven wheel 1, an electric motor 2, a heating resistor 3 and a heat storage device 4. A replaceable battery 6, particularly for supplying power to the electric motor 2, is also assigned to the driving apparatus 10. The driven wheel 1 and the electric motor 2 are connected via a drive shaft 21. The control device 22 assigned to the driving apparatus 10 is illustrated in simplified form as a switch. The control device 22 preferably also performs other functions. Particularly in a first operating state, the electric motor 2 is supplied with electrical energy by the second energy storage device 6. If, in a second operating state, the driven wheel 1 applies a force and/or a torque to the electric motor 2, the control device 22 will interrupt the electrical connection between electric motor 2 and replaceable battery 6, and will complete a circuit that includes the electric motor 2 and the heating resistor 3. In the second operating state, the electric motor 2 is operated as a generator, and supplies electrical energy to the heating resistor 3. The heating resistor 3 converts the electrical energy to heat and supplies this heat to the heat storage device 4. The thermal energy then is also available for other loads. The heating resistor 3 is completely encompassed by the heat storage device 4. It is not illustrated that the heating resistor 3 has ribs, particularly for enlarging the thermally conductive surface of said resistor.

FIG. 2 schematically illustrates a further embodiment of the driving apparatus 10 according to the invention having an absorption-type chiller 7. This embodiment particularly provides the temperature control of the replaceable battery 6. The vehicle is represented as a dashed outline around the driving apparatus 10. In an expansion of the driving apparatus 10 described in reference to FIG. 1, the heat storage device 4 comprises a heat storage means 5, which is provided for phase transition. The heat storage device 4 is provided for supplying thermal power Q to the replaceable battery 6. Further, the heat storage device 4 and/or the replaceable battery 6 can supply thermal power \dot{Q} to the absorption-type chiller 7. These heat flows are preferably controlled by a control device 22 assigned to the driving apparatus 10. Advantageously, the heat storage device 4 and the replaceable battery 6 each have at least one thermocouple 23, 23a. The signals from said thermocouples are detected and processed by the assigned control device 22. The heat storage means 5 is selected such that at a predefined temperature it undergoes a phase transition from solid to liquid. The heat storage means 5 is selected such that the phase transition temperature thereof temporarily drops below the operating temperature of the heating resistor 3 by at least 10 Kelvin. The heat storage means 5 is preferably embodied as a metallic alloy and/or as comprising a substance which undergoes a phase transition directly from solid to gaseous.

FIG. 3 schematically illustrates a further embodiment of the driving apparatus 10 according to the invention, with a temperature control of the passenger compartment 9 of the vehicle, which is represented as a dashed outline. This embodiment particularly provides the temperature control of the passenger compartment 9. In an expansion of the embodiments described in reference to FIG. 1 and FIG. 2, the driving apparatus 10 further comprises two driven wheels 1, 1a and two electric motors 2, 2a. Also assigned to the driving apparatus 10 is a control device 22. The driving apparatus 10 further comprises a plurality of measuring devices, including thermocouples 23, 23a, and speed and torque sensors, not shown here, which are assigned to the drive shafts 21, 21a. The passenger compartment 9 also has a thermocouple 23b. The signals from the measuring devices are detected and evaluated by the control device 22. On the basis of these measured values and the desired temperature of the passenger compartment, the control device 22 initiates heat flows \dot{Q} between the heat storage device 4, the absorption-type chiller 7 and the passenger compartment 9. In this manner, the passenger compartment 9 can be heated and/or cooled. The control device 22 preferably also controls the speeds of the drive shafts 21, 21a and the torques transferred by the electric motors 2, 2a. It is not illustrated that the heating resistor 3 is preferably supplied with energy from the replaceable battery 6.

1-12. (canceled)

13. A vehicle having a driving apparatus, comprising:
at least one propulsion device;
a driving device configured to apply a force and/or a torque to the propulsion device;
an energy conversion device configured to receive energy from the driving device; and
a first energy storage device configured to store energy,
wherein the driving apparatus is configured to assume a first operating state, in which a force and/or a torque are applied to the propulsion device by the driving device, or to temporarily assume a second operating state, in which a force and/or a torque are applied to the driving device by the propulsion device,
wherein in the second operating state, the driving device is configured to supply energy to the energy conversion device,
wherein in the second operating state, the energy conversion device is configured to supply energy to the first energy storage device, and
wherein the energy conversion device is configured to convert electrical energy into thermal energy,
wherein the driving apparatus is assigned a second energy storage device, which is configured to supply energy to the at least one driving device, and the first energy storage device is configured to supply energy to the second energy storage device under predefined conditions.

14. The vehicle having a driving apparatus according to claim 13, wherein the first energy storage device supplies thermal energy to the second energy storage device.

15. The vehicle having a driving apparatus according to claim 13, wherein the predefined conditions are present when the actual temperature of the second energy storage device drops below a minimum operating temperature thereof.

16. The vehicle having a driving apparatus according to claim 13, wherein the second energy storage device has at least one measuring device configured to detect the temperature of the second energy storage device, and in that the driving apparatus is assigned a control device, which compares the temperature detected by the at least one measuring device with a predefined minimum temperature of the second energy storage device, and initiates the introduction of a supply of energy from the first energy storage device to the second energy storage device.

17. The vehicle having a driving apparatus according to claim 13, wherein the energy conversion device is encompassed at least partially by the first energy storage device.

18. The vehicle having a driving apparatus according to claim 13, wherein the first energy storage device has at least one first substance configured to undergo a phase transition, and in that the first substance is selected on the basis of the operating temperatures of the energy conversion device.

19. The vehicle having a driving apparatus according to claim 18, characterized in that the first substance (5) is provided for undergoing a phase transition from solid to liquid, preferably for undergoing a phase transition directly from solid to gaseous.

20. The vehicle having a driving apparatus according to claim 13, wherein an absorption-type chiller is assigned to the driving apparatus.

21. The vehicle having a driving apparatus according to claim 20, wherein the absorption-type chiller is configured to receive energy, under predefined conditions, by the first energy storage device and/or by the second energy storage device.

22. The vehicle having a driving apparatus according to claim 20, further comprising:
a passenger compartment,
wherein the absorption-type chiller carries thermal energy away from the passenger compartment under predefined conditions.

23. The vehicle having a driving apparatus according to claim 13, wherein the driving apparatus comprises at least two propulsion devices.

24. A method for operating a vehicle having a driving apparatus, which comprises at least one propulsion device, a driving device, an energy conversion device and a first energy storage device, wherein the vehicle temporarily assumes a second operating state, in which a force and/or a torque are applied to the driving device by the propulsion device, the method comprising:
supplying, in the second operating state and from the driving device, electrical energy to the energy conversion device;
converting, in the energy conversion device, the electrical energy into thermal energy;
supplying, from the energy conversion device, the thermal energy to the first energy storage device; and
storing the thermal energy supplied by the energy conversion device in the first energy storage device.

25. The method according to claim 24, wherein a second energy storage device that supplies energy to the driving device and an absorption-type chiller are assigned to the vehicle, and the method further comprises exchanging thermal energy between the second energy storage device exchanges thermal energy and the first energy storage device (and/or with the absorption-type chiller under predefined conditions.
